(19) United States
(12) Patent Application Publication
(10) Pub. No.: US 2010/0080886 A1
(43) Pub. Date: Apr. 1, 2010

(54) COFFEE DISPENSING MACHINE

(75) Inventor: Richard HOURIZADEH, Los Angeles, CA (US)

Correspondence Address: MCDERMOTT WILL & EMERY LLP, 600 13TH STREET, N.W., WASHINGTON, DC, 20005-3096, US

(73) Assignee: ASTRA MANUFACTURING, INC.

(21) Appl. No.: 12/571,890

(22) Filed: Oct. 1, 2009

Related U.S. Application Data
(60) Provisional application No. 61/101,778, filed on Oct. 1, 2008.

(51) Int. Cl. A23F 5/10; A47J 31/42; A47J 31/00; A47J 31/40; A47J 31/44; A23F 5/14; A23F 5/00

(52) U.S. Cl. 426/595; 99/286; 99/289 R; 99/287; 99/323; 99/300; 99/288; 426/433; 426/594

(57) ABSTRACT

The instant application describes a programmable apparatus for making coffee that includes a hopper for holding coffee beans; a grinding element for receiving the coffee beans and grinding them to produce ground coffee; and a brewing chamber for receiving programmable quantities of ground coffee and combining the ground coffee with quantities of hot, pressurized water. The programmable apparatus for making coffee also includes a piston for compressing the ground coffee, the piston being arranged to enter the brewing chamber at an open end thereof; an o-ring fitted to the outside of the piston so as to maintain a pressure-tight seal against the wall of the brewing chamber; and a programming element for selectively determining a quantity C of ground coffee to be combined with a quantity W of water in the brewing chamber, the brewing chamber being capable of accommodating more than 14 grams of ground coffee.

### RELATED APPLICATION

This application claims priority from U.S. Provisional Application having Ser. No. 61/101,778 filed Oct. 1, 2008, the entire content of which is hereby incorporated by reference.

### TECHNICAL FIELD

This disclosure relates to systems and methods for brewing a coffee beverage using whole coffee beans and/or ground coffee.

### BACKGROUND

The production and consumption of coffee products has become widespread in recent years. The enhanced popularity of the coffee industry has led to the need for better and more efficient coffee brewing techniques, whether by commercial coffee enterprises for use at popular coffee shops, or by manufacturers of coffee dispensing equipment for commercial and consumer use. The performance of presently available coffee dispensing machines, however, has traditionally been subject to certain limitations.

One such limitation relates to the brewing capacities of traditional coffee and espresso machines. Such machines include, for example, the types of programmable, industrial machines used in popular commercial coffee shops. These machines typically dispense espresso drinks as “single shot” or single-serving. That is, such machines are often designed to dispense one “small” size coffee drink at a time—generally containing coffee equivalent to a single shot of espresso. Where larger espresso drinks requiring two or more shots are needed, the user generally must separately refill the chamber with ground coffee and separately depress the brew button for each serving until the required size coffee drink is dispensed. Coffee machines sold in stores for consumer or office use function in a similar manner.

The heretofore-described capacity problems are not limited to merely the use of espresso, but also extend to whole bean or ground coffee or other ground products in general.

### SUMMARY

In one general aspect, the instant application describes a programmable apparatus for making coffee that includes a hopper for holding coffee beans; a grinding element for receiving the coffee beans and grinding them to produce ground coffee; and a brewing chamber for receiving programmable quantities of ground coffee and combining the ground coffee with quantities of hot, pressurized water.

The programmable apparatus for making coffee also includes a piston for compressing the ground coffee, the piston being arranged to enter the brewing chamber at an open end thereof; an o-ring fitted to the outside of the piston so as to maintain a pressure-tight seal against the wall of the brewing chamber; and a programming element for selectively determining a quantity C of ground coffee to be combined with a quantity W of water in the brewing chamber, the brewing chamber being capable of accommodating more than 14 grams of ground coffee.

The above general aspect may include one or more of the following implementations. For example, the value of C may be 14 grams or less, and the value of W may be at least 8 fluid ounces. Alternatively or additionally, the value of C may be more than 14 grams, and the value of W may be at least 16 fluid ounces. The pressure of the pressurized water may be 135 pounds per square inch or less. Alternatively or additionally, the pressure of the pressurized water may be about 135 pounds per square inch.

The dimensions of the brewing chamber may be selected so that it can accommodate up to about 24 grams of ground coffee. The brewing chamber may be cylindrical and may have an inside diameter of at least 2 inches. The grinding element may comprise burrs set between ¼″ and ⅜″ apart. The grinding element may grind the coffee more coarsely than ground espresso coffee. The apparatus may further include a removable bypass chute configured to enable a user to bypass the grinding element and the brewing chamber and mix a product with coffee dispensed from the apparatus. Alternatively or additionally, the apparatus may further include a removable bypass chute configured to enable a user to bypass the grinding element and mix a product with coffee being brewed in the brewing chamber. The product may include ground coffee beans, flavored coffee, or powder condiments.

The values of C and W may be selected such that C divided by W is 6 grams per fluid ounce or less. The piston may further include, at its bottom surface, a quantity of infusion holes, the diameter of the holes being about 2 mm. The piston may further comprise a layer of Teflon or stainless steal interposed between the o-ring and the outside surface of the piston.

In another general aspect, the instant application describes an apparatus for brewing coffee that includes a brewing chamber having a microfilter; means for compressing ground coffee in the brewing chamber; and means for forcing hot water through the ground coffee in the brewing chamber, thereby causing brewed coffee to emerge through the microfilter. The ratio of weight of ground coffee contained in the brewing chamber to volume of pressurized hot water forced through the ground coffee is 6 grams per fluid ounce or less.

The above general aspect may include one or more of the following features. The apparatus may further include means for storing coffee beans; and means for grinding coffee beans to produce ground coffee. The grinding means may include burrs set between ¼″ and ⅜″ apart. The grinding means may employ a slicing method of grinding.

The grinding means may produce ground coffee more coarsely ground than ground espresso. The brewing chamber may hold at least 14 grams of ground coffee. The amount of pressurized hot water forced through the ground coffee may be greater than 8 fluid ounces. The brewing chamber may hold at least 24 grams of ground coffee. The means for compressing may provide more than 30 pounds of force distributed across the upper surface of the coffee.

The apparatus may further include a removable bypass chute configured to enable a user to bypass the means for grinding and the brewing chamber and mix a product with coffee dispensed from the apparatus. Alternatively or additionally, the apparatus may further include a removable bypass chute configured to enable a user to bypass the means for grinding and mix a product with coffee being brewed in the brewing chamber. The product may include ground coffee beans, flavored coffee, or powder condiments.

The apparatus may further include means for heating the water to more than 198 degrees Fahrenheit. The apparatus may further include means for heating the water to about 204 degrees Fahrenheit. The apparatus may further include means for creating and sustaining a water pressure of between 127 and 141 pounds per square inch. The apparatus may further include means for creating and sustaining a water pressure of 100 pounds per square inch or less. The pressure creating and sustaining means may create and sustain a pressure of about 85 pounds per square inch.

In another general aspect, the instant application describes an apparatus for making coffee that includes a brewing chamber of a generally cylindrical shape that can contain at least 22 grams of ground coffee; a piston for compressing the ground coffee. The piston is arranged to enter the brewing chamber at an open end thereof, and is capable of applying more than 30 pounds of force distributed across the upper surface of the ground coffee. The apparatus further includes an o-ring fitted to the outside of the piston so as to maintain a pressure-tight seal against the wall of the brewing chamber; and a pump for forcing at least 16 fluid ounces of hot, pressurized water through the ground coffee in the brewing chamber.

The above general aspect may include one or more of the following features. For example, the apparatus may further include a grinding element for receiving coffee beans and grinding them to produce the ground coffee and a removable bypass chute configured to enable a user to bypass the grinding element and the brewing chamber and mix a product with coffee dispensed from the apparatus. Alternatively or additionally, the apparatus may include a grinding element for receiving coffee beans and grinding them to produce the ground coffee; and a removable bypass chute configured to enable a user to bypass the grinding element and mix a product with coffee being brewed in the brewing chamber. The product may include ground coffee beans, flavored coffee, or powder condiments.

In another general aspect, the instant application describes a method for brewing coffee, comprising the steps of transferring ground coffee to a brewing chamber; compressing the ground coffee; and forcing pressurized hot water through the ground coffee, thereby causing brewed coffee to emerge through a micro-filter. The ratio of weight of ground coffee contained in the brewing chamber to volume of pressurized hot water forced through the ground coffee is 6 grams per fluid ounce or less. This general aspect may include one or more of the following features.

For example, coffee may be produced by the above-described method. The coffee may be a single serving of about 12 to 20 fluid ounces. The coffee may include a layer of crema. The crema layer may be about ¼″ deep and lasts for at least 10 minutes. The ground coffee may be ground more coarsely than espresso coffee.

The coffee may be ground with burrs set between ¼″ and ⅜″ apart. The coffee may be ground using a slicing method. The amount of ground coffee transferred to the brewing chamber may be between about 13 grams and about 24 grams. The amount of pressurized hot water forced through the ground coffee may be between about 10 fluid ounces and 20 fluid ounces. The brewing chamber may hold at least 24 grams of ground coffee at one time. The coffee may compressed with more than 30 pounds of force distributed across the upper surface of the ground coffee. Alternatively, the coffee may be compressed with about 40 pounds of force distributed across the upper surface of the coffee.

The coffee may be compressed by a piston mechanism. The temperature of the water may be more than 198 degrees Fahrenheit. Alternatively, the temperature of the water may be about 204 degrees Fahrenheit. The pressure of the water may be between 127 and 141 pounds per square inch. The step of forcing water through the coffee may have a duration of more than 20 seconds. The microfilter may be made of a material having a low heat conductivity. The material may be Teflon or stainless steel.

In another implementation, the method may further include the steps of grinding coffee beans to produce the ground coffee transferred to the brewing chamber; and transferring, without grinding, a product into the coffee. Alternatively or additionally, the method may further include the steps of grinding coffee beans to produce the ground coffee transferred to the brewing chamber; and transferring, without grinding, a product into the brewing chamber. The product may include ground coffee beans, flavored coffee, or powder condiments.

### BRIEF DESCRIPTION OF DRAWINGS

FIG. 1 illustrates front and rear views of a coffee dispensing apparatus with a brewing chamber in an open state.

FIG. 2 illustrates front and rear views of the coffee dispensing apparatus shown in FIG. 1 with the brewing chamber in a closed state.

FIG. 3 illustrates more detailed views of the brewing mechanism of the coffee dispersing apparatus shown in FIG. 1.

FIGS. 4-6 illustrate different perspectives of the outer frame of the coffee dispensing apparatus shown in FIG. 1.

FIG. 7 illustrates an exemplary grinder speeding mechanism.

FIG. 8 illustrates an exemplary boiler.

FIG. 9 illustrate an exemplary process 900 used for making coffee.

FIG. 10 illustrates both parts of both the frame and the brewing mechanism of the coffee dispensing apparatus, and related components.

FIG. 11 illustrates an exemplary coffee dispensing apparatus with a single hopper and a grinder.

### DETAILED DESCRIPTION

In the following detailed description, numerous specific details are set forth by way of examples in order to provide a thorough understanding of the relevant teachings. However, present teachings may be practiced without such details. In other instances, well-known methods, procedures, and components have been described at a relatively high-level, without detail, in order to avoid unnecessarily obscuring aspects of the present teachings.

The present application discloses a novel coffee dispensing apparatus which, in one aspect, overcomes the above-described capacity limitations by incorporating the mechanisms and novel enhancements described herein. According to various aspects, the apparatus includes: new structures and/or novel structural enhancements to accommodate an increased brewing capacity and to solve the above-described limitations associated with traditional coffee machines; new features to provide for the accuracy and precision of the timing, sizing and temperature of the brewing mechanism; new features to properly stabilize and support the brewing mechanism and other components within the apparatus; and new features to provide for an increased amount of water that can be handled by the unit.

To provide context, in one specific example, the coffee dispensing apparatus includes one or more hoppers, a grinding element, a brewing chamber, a piston, a gasket, and a programmable element. The one or more hoppers are configured to hold coffee beans. The grinding element is configured to receive the coffee beans and grind them to produce ground coffee. The ground coffee is received by the brewing chamber, which combines the ground coffee with quantities of hot, pressurized water. The brewing chamber may be configured to accommodate between 14 to 30 grams of ground coffee, yielding approximately 20 ounces of coffee directly into a cup or other container.

The piston is arranged to enter the brewing chamber at an open end thereof and compresses the ground coffee. The gasket that may be o-ring fitted to the outside of the piston is used to maintain a pressure-tight seal against the wall of the brewing chamber. The programming element is configured to selectively determine a quantity C of ground coffee to be combined with a quantity W of water in the brewing chamber. The coffee dispensing apparatus may further increase overall efficiency by including a mechanism to enhance grinding speed. Additionally, the coffee dispensing apparatus may include a removable funnel, which allows a user to deposit ground coffee directly into the brewing chamber of the unit.

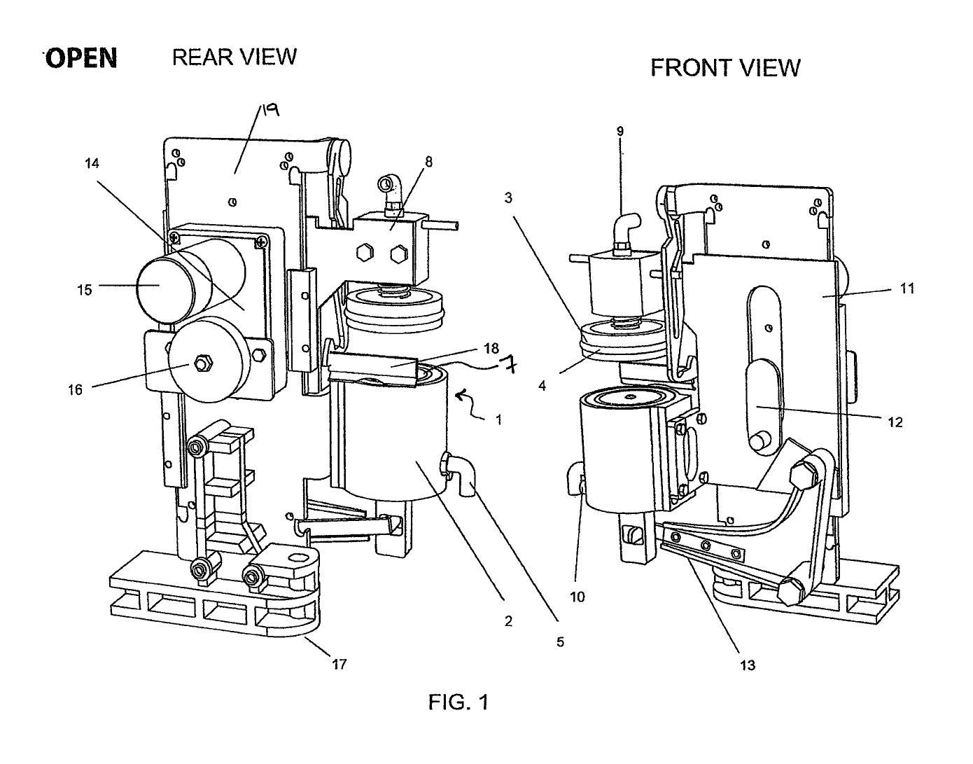

With this overview, reference is now made to exemplary figures that describe the programmable coffee dispensing apparatus of the instant application in more detail. FIG. 1 illustrates front and rear views of a coffee dispensing apparatus with a brewing chamber in an open state. The coffee dispensing apparatus provides for a large brewing mechanism 1 that includes a brewing chamber 2, an upper piston 3, a gasket 4, a dispensing port 5, an inner (lower) piston 7, a piston block 8, and a water supply pipe 9.

The brewing chamber 2 is configured to hold coffee beans. The diameter of the brewing chamber 2 may be constructed to provide for an enhanced brewing capacity. In one example, the diameter of the brewing chamber 2 is at least 2 inches. Due to the increased dimensions, up to approximately 30 grams of ground coffee from the grinder (discussed below) can be deposited into the brewing mechanism 1. As a result, the brewing mechanism 1 can dispense the equivalent of up to approximately 20 ounces or more of coffee directly into a single cup or container.

The brewing mechanism 1 may also include a heating element 10 that regulates the temperature of the brewing mechanism 1. In one implementation, the heating element 10 is enlarged beyond that previously employed in order to maintain the brewing mechanism 1 at the correct temperature. The brewing mechanism 1 may be supported by a support bracket 11 which extends vertically along the plane of the apparatus. The support bracket 11 may be made thicker as well as longer (along a vertical axis of the apparatus) than in previous approaches to be of a sufficient weight to provide the necessary support for the enlarged heating element 10 and brewing chamber 2. In one example, support bracket 11 is constructed to be approximately 3/16″ thick. One of ordinary skill in art, however, recognizes that a different thickness may be appropriate and may be determined, for example, depending on the respective weights of other components or the type of material of the support bracket. The support bracket 11 may also include one or more ridges for attachment of other features, such as support and operational features.

The coffee dispensing apparatus may also include a linkage arm 12, a bottom piston link 13, a gearbox 14, a gearbox motor 15, a cam 16, a bottom support block 17, a sweeper 18, and a reinforcing plate 19. The reinforcing plate 19 extends from the top of the apparatus to bottom support block 17. The linkage arm 12 is coupled to the brewing mechanism 1 and acts as a timer for the brewing mechanism 1. In the implementation shown, linkage arm 12 is mounted substantially in the middle section of the front of the support bracket 11. The length and mating configuration of the linkage arm 12 are designed such that the timing of brewing mechanism 1 is made precise.

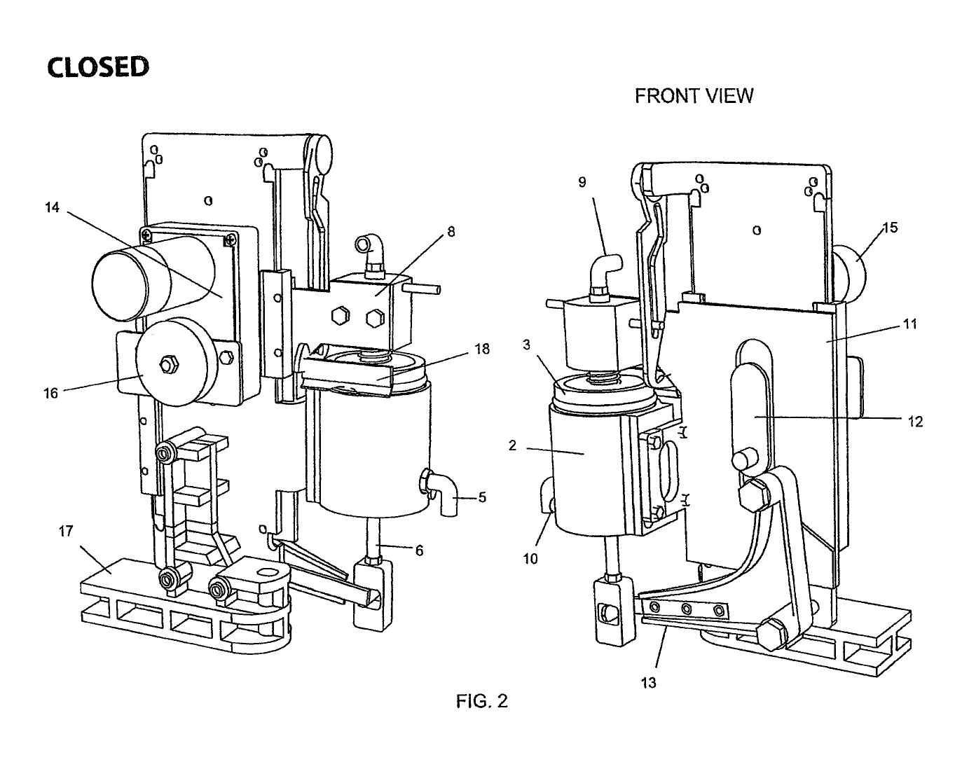

FIG. 2 illustrates front and rear views of the coffee dispensing apparatus shown in FIG. 1 with the brewing chamber in a closed state. The components shown in FIG. 2 are the same as those shown in FIG. 1, except that adjustment rod 6 is shown in FIG. 2. Therefore, for the sake of brevity, FIG. 2 is not described in more detail.

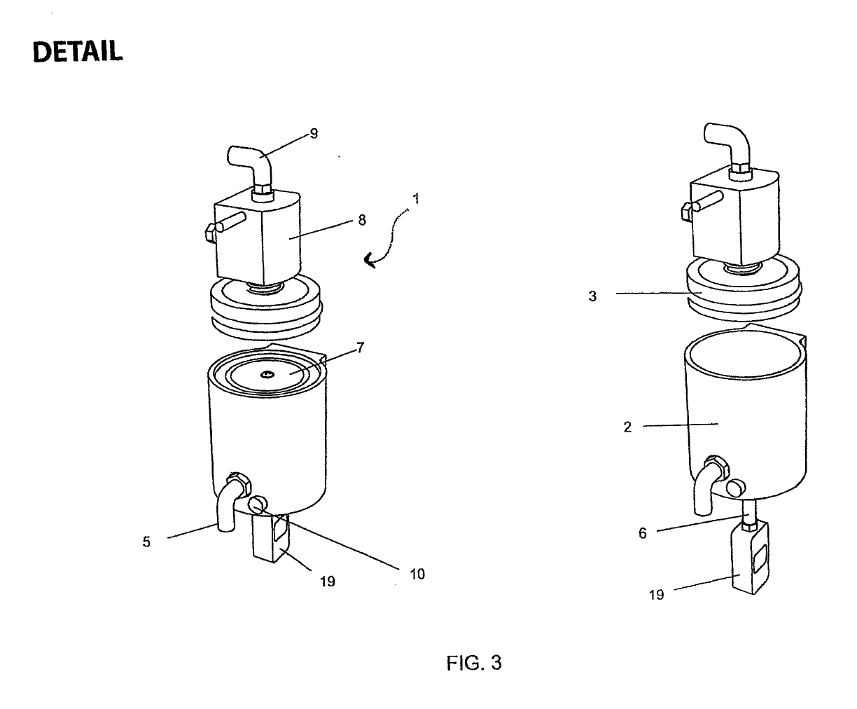

FIG. 3 illustrates more detailed views of the brewing mechanism 1 of the coffee dispersing apparatus shown in FIG. 1. In particular, FIG. 3 shows the piston block 8 and an interior view of a portion of the brewing mechanism 1 including inner piston 7, dispensing port 5, bottom piston 19 and adjustment rod 6 coupled to the bottom piston 19. The piston block 8 is configured to compress the ground coffee as described in more detail below. As shown in FIG. 2, when the ground coffee is compressed (e.g., brewing chamber 2 is in a closed state), the adjustment rod 6 may appear below the brewing chamber 2; whereas, when the ground coffee is not compressed (e.g., the brewing chamber 2 is in an open state), the adjustment rod 6 may be hidden inside the brewing chamber 2 as shown in FIG. 1.

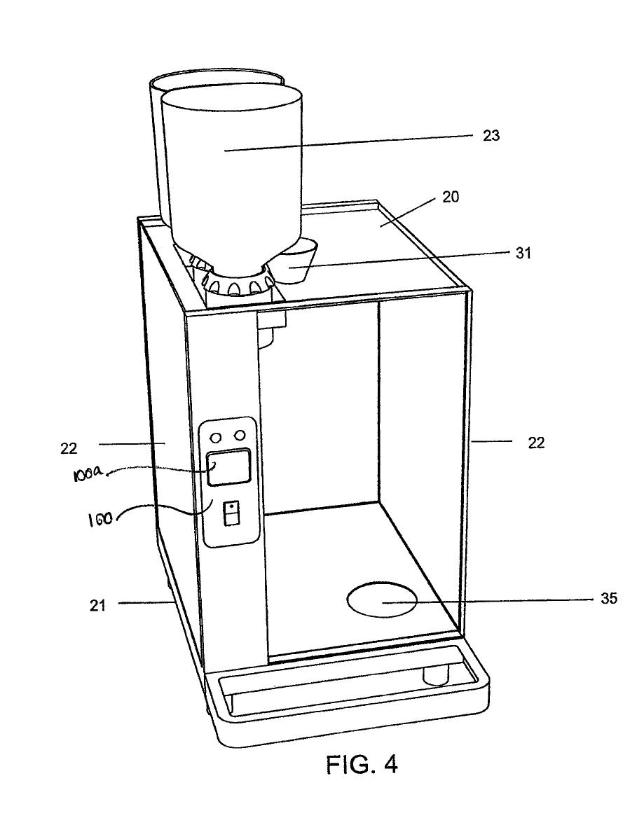

FIG. 4 shows a front perspective view of the frame of the coffee dispensing apparatus and related components. As shown, the frame of the apparatus includes a top piece 20, a bottom piece 21, and two side pieces 22. The frame accommodates two extra large hoppers 23, although in other embodiments, a different number of hoppers may be used. The hoppers 23 are located above the top piece 20 of the apparatus. The hoppers 23 are configured to dispense the whole coffee beans directly into the mouth of the internal grinders 24.

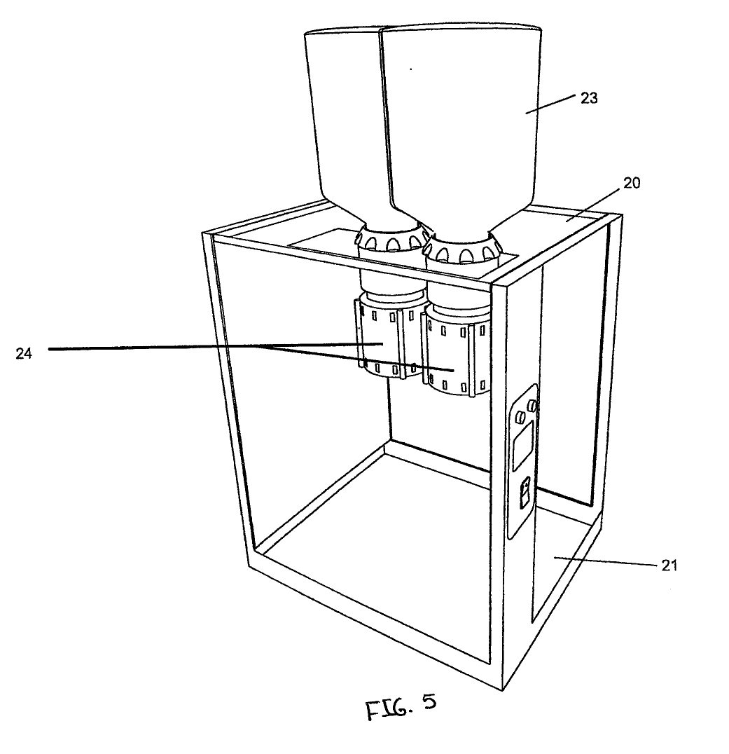

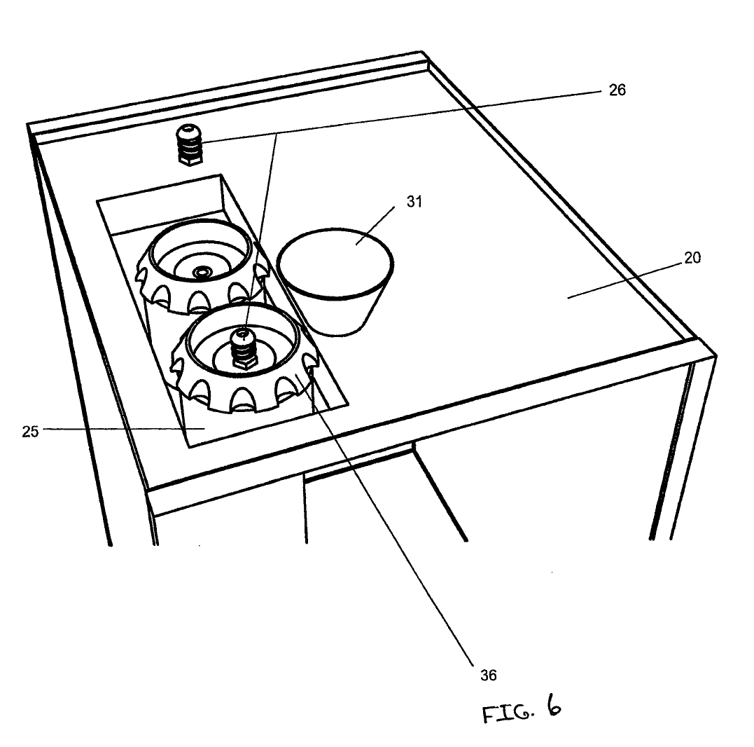

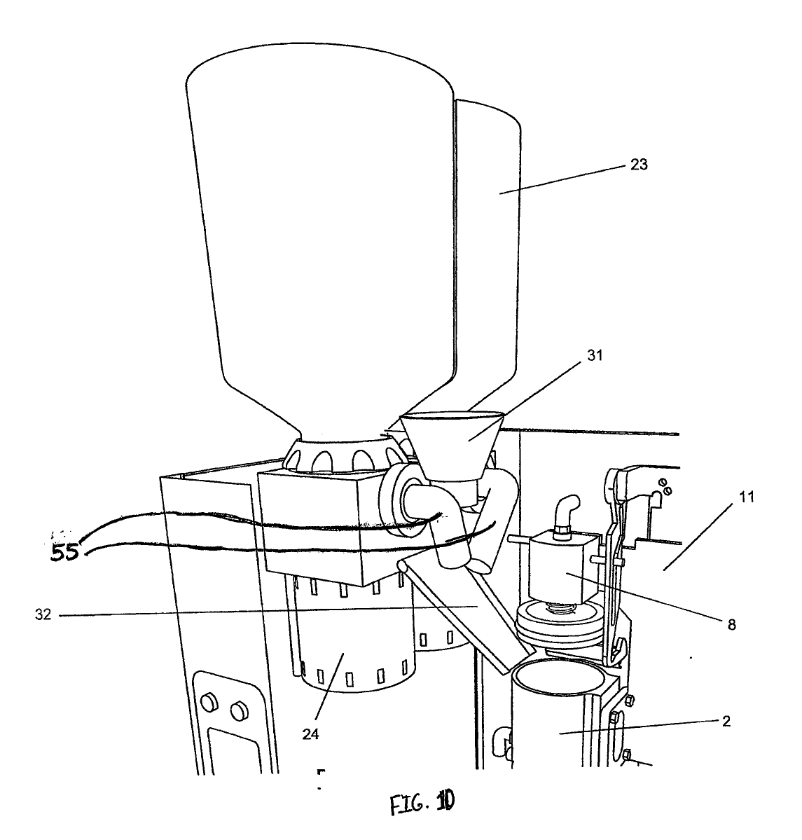

FIG. 5 shows a side perspective view of the frame housing grinders 24. As shown, grinders 24 are mounted inside the frame and positioned at the base of the hoppers 23. The grinders 24 suck and grind or mill whole coffee beans from the hoppers 23 to produce ground coffee. In one implementation, grinders 24 grind the coffee more coarsely than ground espresso coffee. The ground coffee is then transferred via outlets 55 (see FIG. 10) to the brewing chamber 2. As shown in FIG. 6, grinders 24 include a mounting bracket 25 that is affixed to the top piece 20. Associated with each grinder 24 is a grinder speeding mechanism 26.

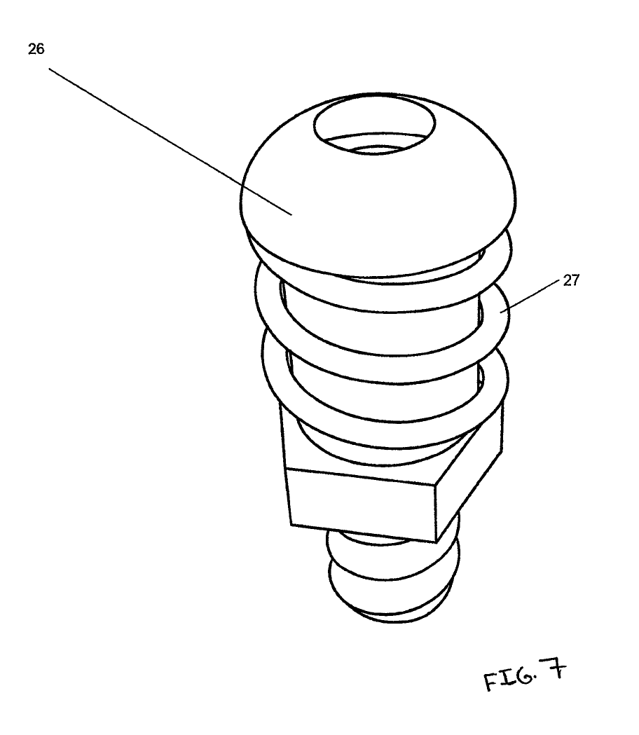

FIG. 7 illustrates a more detailed view of the grinder speeding mechanism 26. As shown, grinder speeding mechanism 26 includes a spring or a coil 27. The spring or coil 27 extends substantially from the mouth of grinder 24 to the motor of grinder 24. The spring or coil 27 provides for a stronger suction. As a result, grinder speeding mechanism 26 can reduce the grinding time over previous solutions for the same amount of coffee. After being ground by grinders 24, the ground coffee is transferred to the brewing chamber 2.

In one implementation, the brewing chamber 2 is approximately 2.5 inches and is configured to hold up to 24 grams of ground coffee. As a result, the brewing mechanism can dispense up to approximately 20 ounces or more of coffee directly into a single cup or container. In another implementation, the brewing chamber can hold up to 24 grams of ground coffee. In this implementation, the brewing chamber 2 may have an inside diameter 2^{1/2}″; inside height of 1^{1/2}″; and outside diameter of 2^{7/16}″.

The enlarged brewing chamber may require larger piston for grounding coffee. Similarly, the enlarged piston will require a larger gasket 4 to o-ring fit around the piston 3. The enlarged piston 3 may cause increased upward force to be exerted on the piston. This increased upward force may in turn have an effect of breaking the gasket 4 and permitting water to escape the brewing chamber 2. To remedy this problem, in one example, a thicker o-ring is installed. In another example, the water pressure may be reduced to cancel out the increase force in the piston area, thereby reducing the force on the piston. For example, the coffee may be brewed at pressure between 100 psi to 135 psi. In one specific example, the pressure may be 120 psi.

The upper piston 3 compresses ground coffee against the lower piston 7 with a force of about 30 to 40 pounds. The upper piston 3 is driven by the piston block 8 which is in turn driven by gearbox motor 15. Alternatively, the upper piston 3 may be driven by other mechanism. For example, the upper piston 3 may be driven manually. If driven manually, the required force should be between 35 and 45 pounds. To output brewed coffee, pressurized, hot water is passed through the ground coffee. The water may be heated by an immersion heater, heat exchanger, or other heat sources.

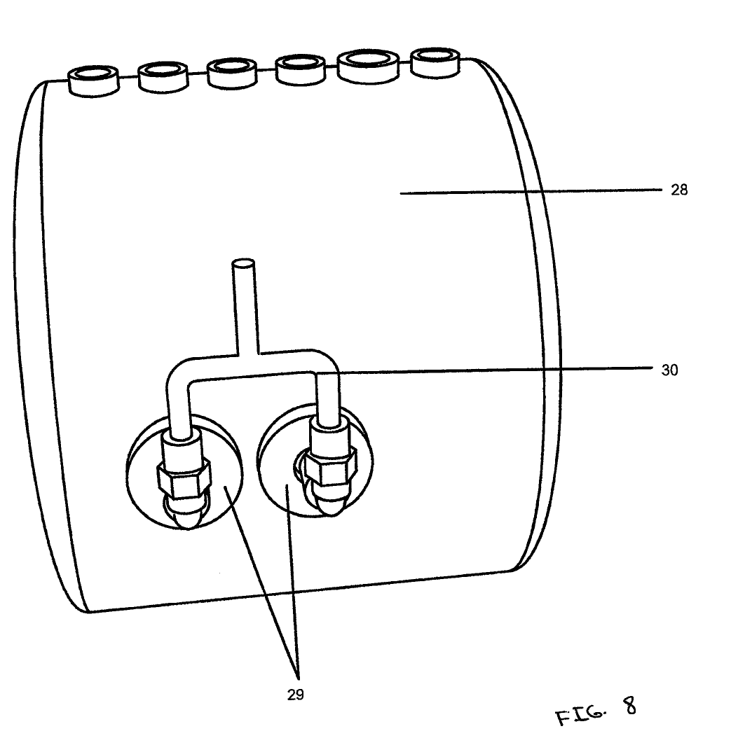

FIG. 8 illustrates a large boiler 28 including heat exchangers 29 having a parallel output port 30. The parallel heat exchange configuration increases total water capacity of the apparatus by allowing the boiler 28 to bring in, store and release more hot water in a single operation. The temperature of the hot water may be below the boiling point but may be high enough to produce a hot coffee. In one example, the temperature of the hot water is between 190 to 203 degrees Fahrenheit. One of ordinary skill in the art, however, recognizes that other temperatures may be used.

In one implementation, the hot water is pressurized and forced through upper piston 3 via water supply pipe 9. The pressure of the pressurized water may be between 127 to 141 psi. The bottom of the piston 3 may include a hole that admits the pressurized hot water into the brewing chamber 2. The brewed coffee emerges from brewing chamber 2 through dispensing port 5 and is poured into a cup (or a container). The cup may have different capacities. In one example, the cup may have a capacity or serving size of 12 to 20 ounces. In another example, the cup may have a capacity or serving size of 5, 6, or 24 ounces. Other capacities or serving sizes are also possible.

Moving forward, the coffee dispensing apparatus according to the instant application may be programmable. To this end, the coffee dispensing apparatus may include a programmable element 100 as shown in FIG. 4. In one example, the programmable element 100 is configured to selectively determine a quantity of ground coffee that is transferred to the brewing chamber 2 along with the amount of hot water that is forced to go through the ground coffee. For another example, the coffee dispensing apparatus may control the coarseness or fitness of the ground coffee produced by grinders 24; the temperature, pressure, and amount of the produced hot water; the amount of force exerted by the upper piston 3; the amount of coffee that dispenses from the brewing chamber; and the number of brewing cycles. The programming may be carried out by a processor or may be carried out by turning a nub or an adjustable screw. In one example, the processor is configured to receive, from a user, an input regarding for example, the quantity of ground coffee and the quantity of water to be combined with each other, via a panel 100a. The panel 100a may be a touch screen implementing sensors or may have a manual buttons for receiving inputs.

The brewing cycle includes transferring a quantity C grams of ground coffee to the brewing chamber 2, compressing the ground coffee, passing W fluid ounces of pressurized hot water through the ground coffee so as to produce a quantity of coffee beverage, and expelling the used coffee beverage from the brewing chamber. The programming element selectively adjusts the number of brewing cycles to produce quantity of coffee desired and selectively determines a quantity C of ground coffee to be combined with a quantity W of water in the brewing chamber for each brewing cycle to adjust concentration to the desired level. In one example, the value of C is 14 grams or less, and the value of W is at least 8 fluid ounces. In another example, the value of C is more than 14 grams, and the value of W is at least 16 fluid ounces.

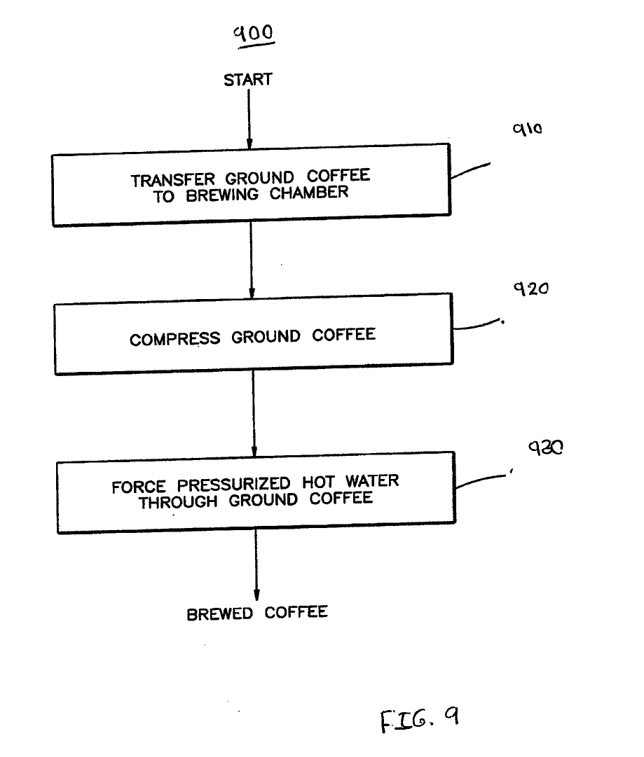

FIG. 9 illustrate an exemplary process 900 used for making coffee. Process 900 begins with ground coffee transferred to brewing chamber (910). The coffee may be ground more coarsely than espresso coffee. To this end, the coffee may be ground in a grinder or mill of a European burr type, with adjustable burrs, although other types of coffee grinders or mills may be used. The burrs may be arranged to grind the coffee using a slicing action. The burrs may be adjusted to be set between ¼″ and ⅜″ apart, although other spacing may be used.

The amount of ground coffee transferred to the brewing chamber may be between 13 grams and 24 grams. However, other amounts are also contemplated. Once the ground coffee is located within brewing chamber, the ground coffee is compressed (920). The coffee may be compressed using a piston driven by, for example, a spring or a motor. Alternatively, the coffee may be compressed by hand. In one implementation, the coffee is compressed with more than 30 pounds of force distributed across the upper surface of the ground coffee. In another implementation, the coffee is compressed with about 40 pounds of force distributed across the upper surface of the ground coffee.

The process 900 also includes a step of forcing pressurized hot water through the ground coffee to thereby cause brewed coffee to emerge through a microfilter (930). In one implementation, the ratio of weight of ground coffee contained in the brewing chamber to volume of pressurized hot water forced through the ground coffee is 6 grams per fluid ounce or less. The microfilter may be made of a material having a low heat conductivity. The material may be Teflon. Alternatively, the material may be Teflon or stainless steel.

The amount of the pressurized water forced through the ground coffee may be between 10 fluid ounce and 20 fluid ounce. The temperature of the water is more than 198 degrees Fahrenheit, in one example. In another example, the temperature of the water is about 204 degrees Fahrenheit. The pressure of the water may be between 127 and 141 psi. The step of forcing water through ground coffee may have a duration of more than 20 seconds.

Those skilled in the art will recognize that the present teachings are amenable to a variety of modifications and/or enhancements. For example, as shown in FIGS. 4, 5, and 10, the coffee dispensing apparatus may include a removable bypass chute 31 located at the top of the machine. The bypass chute 31 may connect to the apparatus, for example, via an opening in the top piece 20. In one configuration, referring to FIG. 10, the opening is located above an internal slider 32 that directs the ground product into the brewing chamber 2. In one implementation, the bypass chute 31 is configured to enable a user to bypass the grinders 24 and the brewing chamber 2 and mix a product with coffee dispensed from the apparatus. That is, the bypass chute 31 can enable the user to add the product directly to the cup in which the coffee is being dispended. In another implementation, the bypass chute 31 is configured to enable a user to bypass the grinders 24 and mix a product with coffee being brewed in the brewing chamber 2. That is, the bypass chute 31 can transfer the product into the brewing chamber 2 before incorporating the product into the coffee dispensed from the apparatus. The product may include, for example, ground coffee beans, flavored coffee, powder condiments or other ground products.

In another implementation, the coffee dispensing apparatus may also contain a “cut-out” in the front of the frame behind the waste disposal drawer. This “cut-out” may allow a user to connect a hose, pipe, tube, or other cylindrical shaped device through the cut-out and into the apparatus. The hose, pipe, tube, or other device allows the user to direct waste from the apparatus directly into an independent waste disposal or waste retention unit. If no hose, pipe, tube, or other product is attached or otherwise inserted into the “cut-out” according to this embodiment, the disposal may be deposited into the waste disposal drawer via a waste dispensing access port 35.

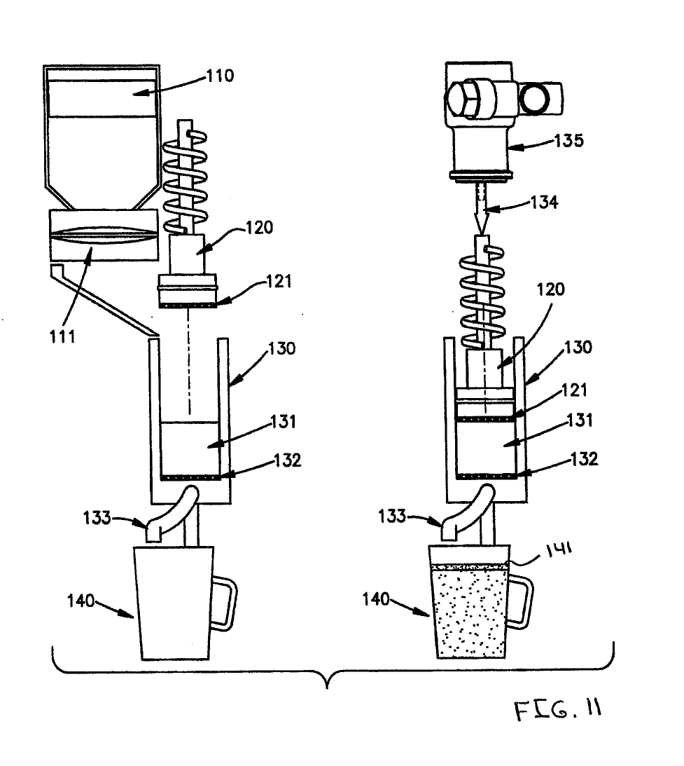

In yet another implementation, instead of employing two hoppers and two grinders, the coffee dispensing apparatus may employ a single hopper and a grinder. FIG. 11 illustrates one example, of such a coffee dispensing mechanism. As shown, the coffee dispensing mechanism includes a single hopper 110 and a single grinding element 111. The grinding element 111 may be of European burr type, with adjustable burrs. The burrs of the grinding element 111 are arranged to grind the coffee with a slicing action. In one example, the grinding element 111 comprises burrs set between ¼″ and ⅜″ apart.

The ground coffee 131 is poured into brewing chamber 130 and is compressed via piston 120. Then, the pressurized hot water 134 is passed through the ground coffee 131 located inside brewing chamber 130. As shown, the pressurized hot water 134 is first forced through the piston 120 and the microfilter 121 via a pump 135 before passing through the ground coffee. The amount of pressurized hot water forced through the ground coffee may be greater than 8 fluid ounces. In one example, the pump forces at least 16 fluid ounce of hot, pressurized water through the ground coffee in the brewing chamber. The bottom of piston 120 includes fusion holes that admit water through microfilter 121 into the brewing chamber 130. The microfilter 121 acts as a shower screen to spread water evenly over the grounds and also prevent grounds from escaping out the top of the brewing chamber 130. In one embodiment, the infusion holes are enlarged to allow more water through the grinds in order to make a larger cup of coffee. In one example, the size of the infusion holes is about 2 mm and there are 5 infusion holes. The microfilter 121 may be made of metal or of a low heat-conductivity material (e.g., Teflon or PVC plastic). After passing through the ground coffee, the pressurized hot water goes through a second filter 132 and brewed coffee emerges from pipe 133. The second filter 132 may be made of the same material as the first filter 121. The coffee produced by the above apparatus may include a crema layer 141. The crema layer 141 may be about ¼″ thick; however, other depths may be achieved based on different coffee blends.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A programmable apparatus for making coffee comprising:
a hopper for holding coffee beans;
a grinding element for receiving the coffee beans and grinding them to produce ground coffee;
a brewing chamber for receiving programmable quantities of ground coffee and combining the ground coffee with quantities of hot, pressurized water;
a piston for compressing the ground coffee, the piston being arranged to enter the brewing chamber at an open end thereof;
an o-ring fitted to the outside of the piston so as to maintain a pressure-tight seal against the wall of the brewing chamber; and
a programming element for selectively determining a quantity C of ground coffee to be combined with a quantity W of water in the brewing chamber, the brewing chamber being capable of accommodating more than 14 grams of ground coffee.

2. The apparatus of claim 1 wherein the value of C is 14 grams or less, and the value of W is at least 8 fluid ounces.

3. The apparatus of claim 1 wherein the value of C is more than 14 grams, and the value of W is at least 16 fluid ounces.

4. The apparatus of claim 3 wherein the pressure of the pressurized water is 135 pounds per square inch or less.

5. The apparatus of claim 4 wherein the pressure of the pressurized water is about 135 pounds per square inch.

6. The apparatus of claim 3 wherein the dimensions of the brewing chamber are selected so that it can accommodate up to about 24 grams of ground coffee.

7. The apparatus of claim 3 wherein the brewing chamber is cylindrical and has an inside diameter of at least 2 inches.

8. The apparatus of claim 1 wherein:
the grinding element comprises burrs set between ¼″ and ⅜″ apart, and
the grinding element grinds the coffee more coarsely than ground espresso coffee.

9. The apparatus of claim 1, further comprising a removable bypass chute configured to enable a user to bypass the grinding element and the brewing chamber and mix a product with coffee dispensed from the apparatus.

10. The apparatus of claim 1, further comprising a removable bypass chute configured to enable a user to bypass the grinding element and mix a product with coffee being brewed in the brewing chamber.

11. The apparatus of claim 9 or claim 10, wherein the product includes ground coffee beans, flavored coffee, or powder condiments.

12. The apparatus of claim 1 wherein the values of C and W are selected such that C divided by W is 6 grams per fluid ounce or less.

13. The apparatus of claim 1 wherein the piston further comprises, at its bottom surface, a quantity of infusion holes, the diameter of the holes being about 2 mm.

14. The apparatus of claim 1 wherein the piston further comprises a layer of Teflon or stainless steel interposed between the o-ring and the outside surface of the piston.

15. An apparatus for brewing coffee, comprising:
a brewing chamber having a microfilter;
means for compressing ground coffee in the brewing chamber; and
means for forcing hot water through the ground coffee in the brewing chamber, thereby causing brewed coffee to emerge through the microfilter;
wherein the ratio of weight of ground coffee contained in the brewing chamber to volume of pressurized hot water forced through the ground coffee is 6 grams per fluid ounce or less.

16. The apparatus of claim 15 further comprising:
means for storing coffee beans; and
means for grinding coffee beans to produce ground coffee.

17. The apparatus of claim 16 wherein the grinding means comprises burrs set between ¼″ and ⅜″ apart.

18. The apparatus of claim 16 wherein the grinding means employs a slicing method of grinding.

19. The apparatus of claim 16 wherein the grinding means produces ground coffee more coarsely ground than ground espresso.

20. The apparatus of claim 15, further comprising a removable bypass chute configured to enable a user to bypass the means for grinding and the brewing chamber and mix a product with coffee dispensed from the apparatus.

21. The apparatus of claim 15, further comprising a removable bypass chute configured to enable a user to bypass the means for grinding and mix a product with coffee being brewed in the brewing chamber.

22. The apparatus of claim 20 or claim 21, wherein the product includes ground coffee beans, flavored coffee, or powder condiments.

23. The apparatus of claim 15 wherein the brewing chamber can hold at least 14 grams of ground coffee.

24. The apparatus of claim 15 wherein the amount of pressurized hot water forced through the ground coffee is greater than 8 fluid ounces.

25. The apparatus of claim 15 wherein the brewing chamber can hold at least 24 grams of ground coffee.

26. The apparatus of claim 15 wherein said means for compressing provides more than 30 pounds of force distributed across the upper surface of the coffee.

27. The apparatus of claim 15 further comprising means for heating the water to more than 198 degrees Fahrenheit.

28. The apparatus of claim 15 further comprising means for heating the water to about 204 degrees Fahrenheit.

29. The apparatus of claim 15 further comprising means for creating and sustaining a water pressure of between 127 and 141 pounds per square inch.

30. The apparatus of claim 15 further comprising means for creating and sustaining a water pressure of 100 pounds per square inch or less.

31. The apparatus of claim 30 wherein the pressure creating and sustaining means creates and sustains a pressure of about 85 pounds per square inch.

32. An apparatus for making coffee comprising:
a brewing chamber of a generally cylindrical shape that can contain at least 22 grams of ground coffee;
a piston for compressing the ground coffee, the piston being arranged to enter the brewing chamber at an open end thereof, and capable of applying more than 30 pounds of force distributed across the upper surface of the ground coffee;
an o-ring fitted to the outside of the piston so as to maintain a pressure-tight seal against the wall of the brewing chamber; and
a pump for forcing at least 16 fluid ounces of hot, pressurized water through the ground coffee in the brewing chamber.

33. The apparatus of claim 32, further comprising:
a grinding element for receiving coffee beans and grinding them to produce the ground coffee; and
a removable bypass chute configured to enable a user to bypass the grinding element and the brewing chamber and mix a product with coffee dispensed from the apparatus.

34. The apparatus of claim 32, further comprising:
a grinding element for receiving coffee beans and grinding them to produce the ground coffee; and
a removable bypass chute configured to enable a user to bypass the grinding element and mix a product with coffee being brewed in the brewing chamber.

35. The apparatus of claim 33 or claim 34, wherein the product includes ground coffee beans, flavored coffee, or powder condiments.

36. A method for brewing coffee, comprising the steps of:
transferring ground coffee to a brewing chamber;
compressing the ground coffee; and
forcing pressurized hot water through the ground coffee, thereby causing brewed coffee to emerge through a micro-filter; wherein the ratio of weight of ground coffee contained in the brewing chamber to volume of pressurized hot water forced through the ground coffee is 6 grams per fluid ounce or less.

37. Coffee produced by the method of claim 36.

38. The coffee of claim 37 comprising a single serving of about 12 to 20 fluid ounces.

39. The coffee of claim 37 comprising a layer of crema.

40. The coffee of claim 39 wherein the crema layer is about ¼″ deep and lasts for at least 10 minutes.

41. The method of claim 36 wherein the ground coffee is ground more coarsely than espresso coffee.

42. The method of claim 41 wherein the coffee is ground with burrs set between ¼″ and ⅜″ apart.

43. The method of claim 36 wherein the coffee is ground using a slicing method.

44. The method of claim 36 wherein the amount of ground coffee transferred to the brewing chamber is between about 13 grams and about 24 grams.

45. The method of claim 36 wherein the amount of pressurized hot water forced through the ground coffee is between about 10 fluid ounces and 20 fluid ounces.

46. The method of claim 36 wherein the brewing chamber can hold at least 24 grams of ground coffee at one time.

47. The method of claim 37 wherein the coffee is compressed with more than 30 pounds of force distributed across the upper surface of the ground coffee.

48. The method of claim 47 wherein the coffee is compressed with about 40 pounds of force distributed across the upper surface of the coffee.

49. The method of claim 48 wherein the coffee is compressed by a piston mechanism.

50. The method of claim 36 wherein the temperature of the water is more than 198 degrees Fahrenheit.

51. The method of claim 50 wherein the temperature of the water is about 204 degrees Fahrenheit.

52. The method of claim 36 wherein the pressure of the water is between 127 and 141 pounds per square inch.

53. The method of claim 36 wherein the step of forcing water through the coffee has a duration of more than 20 seconds.

54. The method of claim 36 wherein the microfilter is made of a material having a low heat conductivity.

55. The method of claim 54 wherein the material is Teflon or stainless steel.

56. The method of claim 54 wherein the material is PVC plastic.

57. The method of claim 37 further comprising the steps of:
grinding coffee beans to produce the ground coffee transferred to the brewing chamber; and
transferring, without grinding, a product into the coffee.

58. The method of claim 36, further comprising the steps of:
grinding coffee beans to produce the ground coffee transferred to the brewing chamber; and
transferring, without grinding, a product into the brewing chamber.

59. The method of claim 57 or claim 58, wherein the product includes ground coffee beans, flavored coffee, or powder condiments.
